(19) United States
(12) Patent Application Publication
(10) Pub. No.: US 2008/0195264 A1
(43) Pub. Date: Aug. 14, 2008

(54) METHOD OF AUTOMATICALLY MANAGING THE SPEED OF AN AIRCRAFT IN TURBULENT AIR AND DEVICE FOR ITS IMPLEMENTATION

(75) Inventors: Guy Deker, Cugnaux (FR); Jerome Sacle, Toulouse (FR); Francois Coulmeau, Seilh (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-Seine (FR)

(21) Appl. No.: 11/923,283

(22) Filed: Oct. 24, 2007

(30) Foreign Application Priority Data
Oct. 24, 2006 (FR) 06 09301

(51) Int. Cl. G05D 1/00

(52) U.S. Cl. 701/7

(57) ABSTRACT

The invention relates to a method of automatically managing the flight of an aircraft in turbulent air comprising notably the determination of the current speed (V_{c}), of an optimal turbulence speed (Vₜ), of a current thrust value (P). The data relating to a turbulence is acquired. An optimal turbulence speed is determined. Measuring a deviation (Δ) between the current speed (V_{c}) and the turbulence speed (Vₜ). Comparing the deviation (Δ) and a maximum deviation value (Δₘₐₓ). Iterating k times of the previous three steps, to determine whether the deviation (Δ) is greater than the maximum deviation (Δₘₐₓ) for the k^{th} consecutive time, and the readjustment of the current thrust (P) so as to reduce the deviation (Δ) to a value less than that of the maximum deviation (Δₘₐₓ) and to make the current speed (V_{c}) converge to the turbulence speed (Vₜ).

### RELATED APPLICATIONS

The present application is based on, and claims priority from, France Application Number 06 09301, filed Oct. 24, 2006, the disclosure of which is hereby incorporated by reference herein in its entirety.

### TECHNICAL FIELD

The invention relates to the navigational aid for an aircraft and more particularly the management of its speed when turbulence is encountered.

### BACKGROUND OF THE INVENTION

The safety of flights is the first priority of airlines, followed by comfort and operating cost during flight. Incidents can arise when turbulences are observed during the flight. The consequences go from simple discomfort to loss of control of the craft.

Turbulences can have various origins: wake turbulences, convective turbulences, clear air turbulences (CAT) or windshears.

Wake turbulences, known by the term wake vortices, are feared when an airplane that is lighter than its predecessor gets too close to the latter and the wind does not rapidly dissipate these wind “breakers”. This happens especially on takeoff and landing because of the runway which escalates the dangerous effects.

Convective turbulences are related to the shearings between the downward and upward movements in the cumuliform cloud masses traversed such as cumulonimbus and so-called tower-cumulus. They are localized (in and under the clouds) and are sometimes difficult to forecast. However, it may be possible to succeed in anticipating them depending on the meteorological context, and the suitable speed is then applied by anticipation.

Clear air turbulences are due to the energy of the average wind flux at high altitude or the transition between two air masses having different speeds as in the environs of jet-streams. Jet-streams are wind currents of small thickness and average width, a few tens of kilometers, undulating at high speed around the earth at high altitude. In general encountered while cruising, clear air turbulences are the most dangerous since they are not detected. It sometimes happens that unbelted persons such as air stewards are severely injured.

Windshears are related to abrupt variations or to wind reversals encountered on the approaches to certain airports in certain weather conditions or else to fast variations encountered in the environs of or when crossing jet-streams. This type of turbulence induces wind gradients which can quite simply cause the airplane to stall.

Generally, turbulences make the flight uncomfortable. It is necessary to reduce the speed of the airplane to a so-called turbulence speed so as, on the one hand, to attenuate the vibrations of the airplane that are disliked by passengers and, on the other hand, to avoid structural embrittlement or sometimes breakage. Furthermore, turbulences can also make piloting uncomfortable (typing on a keyboard is not easy) and lead to disengaging an automatic piloting system which therefore no longer affords its aid.

Generally, the speed of an aircraft is anticipated and managed by a system designated Flight Management System that will be referred to as FMS subsequently. In particular, when the FMS is in so-called “speed auto” mode, the speed is managed by the FMS which is then capable of calculating predictions notably on the flight time to arrival and fuel consumption. Conversely, when the FMS is in so-called “speed selected” mode, the speed is imposed by the pilot. In “speed auto” mode, to regulate the speed, the FMS addresses a speed setpoint to the automatic pilot. A functionality of the automatic pilot, called auto-thrust, then makes it possible to adjust the thrust of the engines so as to comply with the speed setpoint requested by the FMS. However, this system is not suitable in turbulent air. The numerous wind gusts induce the auto-thrust to make continual thrust adjustments so as to comply with the speed setpoint. This phenomenon has the effect of increasing fuel consumption and of causing the engine parts to wear prematurely.

A solution therefore consists in the pilot deactivating the automatic pilot. The pilot is then in charge of defining the thrust required in order to comply with the turbulence speed. The thrust is determined by a table provided by the constructor of the aircraft. This solution is not fully satisfactory since this maneuver is entirely manual and it increases the pilot's workload. Moreover, when the FMS is no longer in “speed auto”, its predictions are no longer as precise and this greatly handicaps the precision of the flight especially when it is subject to an arrival time constraint.

Specifically, in “speed selected” mode, the predictions are based on the speed maintained up to the next waypoint exhibiting a speed constraint, where the pilot is able to return to auto mode. Beyond this point, they are based on the speed ECON (for economic). The speed ECON is an optimal speed taking account at one and the same time of the economic optimum defined by the commercial policy of the company, and the speed or time constraint or constraints which may impact the results. It involves a compromise between the cost of the duration of the flight and the cost of the fuel consumption. In the cruising phase the waypoints exhibiting speed constraints are spaced very far apart, typically several tens of nautical miles (the customary symbol for which is Nm). However, turbulences are often very localized and the actual flight distance with the turbulence speed will then be much less than the distance estimated by the prediction calculation. This phenomenon strongly affects the precision of the predictions.

### SUMMARY OF THE INVENTION

The invention is aimed at alleviating the problems cited previously by proposing a method making it possible to calculate an optimal turbulence speed and which simplifies and automates the management of the speed when turbulence is encountered. The method according to the invention thus makes it possible to reduce the workload of the pilot and to retain the autofacilities of the FMS as well as the associated predictions during the turbulence.

For this purpose, the subject of the invention is a method of automatically managing the flight of an aircraft in turbulent air comprising notably the determination of the current speed V_{c}, of an optimal turbulence speed Vₜ, of a current thrust value P, which furthermore comprises the following steps:
the acquisition of the data relating to a turbulence,
the determination of an optimal turbulence speed,
the measurement of a deviation Δ between the current speed V_{c} and the turbulence speed Vₜ,
the comparison between the deviation Δ and a maximum deviation value Δₘₐₓ,
the iteration k times of the previous three steps, to determine whether the deviation Δ is greater than the maximum deviation Δₘₐₓ for the k^{th} consecutive time, and the readjustment of the current thrust P so as to reduce the deviation Δ to a value less than that of the maximum deviation Δₘₐₓ and to make the current speed V_{c} converge to the turbulence speed Vₜ.

Advantageously, the step of readjusting the current thrust is done progressively.

Advantageously, the data relating to a turbulence comprise the altitude and the strength of the turbulence.

Advantageously, the optimal turbulence speed is calculated as a function of the altitude and of the mass of the aircraft.

Advantageously, the optimal turbulence speed is equal to a value provided by the constructor.

Advantageously, the optimal turbulence speed is determined manually by the pilot so as to be substituted temporarily for the calculated value.

Advantageously, the method of automatically managing the flight of an aircraft in turbulent air according to the invention comprises the automatic determination of the optimal turbulence speed after stopping the manual determination of said speed by the pilot.

Advantageously, the method of automatically managing the flight of an aircraft in turbulent air according to the invention furthermore comprises a step of predicting parameters such as the fuel consumption and the flight duration, on the basis of the current speed convergent to the turbulence speed, said turbulence speed being assumed to be maintained automatically for prediction purposes for an estimated duration of turbulence.

Advantageously, if the turbulence conditions have not terminated after this duration has elapsed, and if the pilot has not released the turbulence mode, the predictions assume that the turbulence speed is prolonged for a new duration and so on and so forth without it being able to exceed the end of the cruising phase, that is to say up to the start of the descent phase.

The subject of the invention is also a device for aiding navigation in turbulent air having available a man-machine interface comprising a display means and control buttons disposed on either side of said display means and wherein said man-machine interface comprises means dedicated to the activation of the turbulence mode.

Advantageously, the device for aiding navigation in turbulent air according to the invention furthermore comprises means for displaying a message signaling the activation or the deactivation of the turbulence mode.

Advantageously, the man-machine interface furthermore comprises means dedicated to the deactivation of the turbulence mode.

The invention will be better understood and other advantages will become apparent on reading the detailed description and with the aid of the figures, among which:

### BRIEF DESCRIPTION OF THE DRAWINGS

FIG. 1 represents an architecture of an FMS according to the known art.

FIG. 2 represents an exemplary display of the indication of the current speed of the aircraft complying with a range of turbulence speeds, used in the invention.

FIG. 3 represents an exemplary display of the indication of the current speed of the aircraft not complying with a range of turbulence speeds, used in the invention.

FIG. 4 represents a first exemplary display of the man-machine interface of the FMS when the method according to the invention is activated.

FIG. 5 represents a second exemplary display of the man-machine interface of the FMS when the method according to the invention is activated.

### DETAILED DESCRIPTION OF THE INVENTION

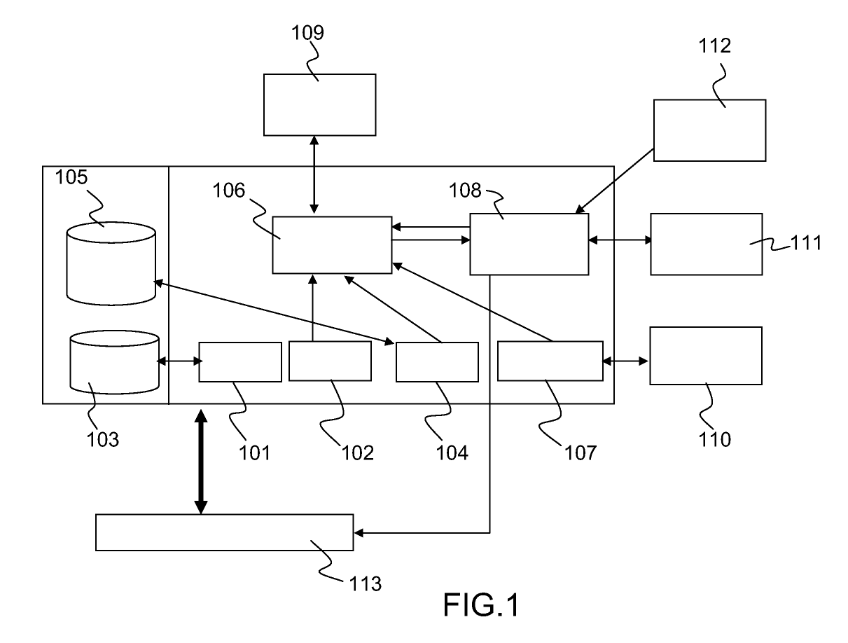

Generally, an FMS architecture, illustrated in FIG. 1, comprises a set of functions and a basic set of databases such as monitoring of the context 108, guidance 106, predictions 104 notably regarding flight time and fuel consumption, flight plan 101 consisting of a string of points and segments connecting them, trajectory calculation 102 established on the basis of the elements of the flight plan and the setpoints for tracking the flight plan and location 107. The set of databases comprises notably a navigation database 103 and a database of performance ratings 105 containing various characteristics and limits of the aircraft.

The FMS is interfaced with an automatic pilot 109, sensors 110 for location, a radio link (digital or analog) 111 with other airplanes or with the air traffic control enabling them to exchange information notably regarding their position (longitude, latitude, altitude) and their speed or else relating directly to turbulences, as well as a weather radar 112. The FMS can be controlled by a man-machine interface 113 comprising notably screens and keyboards.

An exemplary embodiment of the method according to the invention in the architecture presented makes it possible to maintain the relationship between the automatic pilot function 109 and guidance function 106 of the FMS in the event of turbulence. This is not the case currently.

The method of automatically managing the flight of an aircraft in turbulent air according to the invention comprising notably the determination of the current speed V_{c}, of an optimal turbulence speed Vₜ, of a current thrust value P furthermore comprises the following steps:
the acquisition of the data relating to a turbulence; these data can be recovered through the radio link 111 mentioned previously.
the determination of an optimal turbulence speed, which can be determined in several ways. It can be calculated as a function of the altitude and of the mass of the aircraft using a performance database. It can be equal to a default value provided by the constructor. Finally, it can be determined manually by the pilot.
the measurement of a deviation Δ between the current speed V_{c} and the turbulence speed Vₜ,
the comparison between the deviation Δ and a maximum deviation value Δₘₐₓ; a maximum deviation Δₘₐₓ is tolerated between the current speed V_{c} and the turbulence speed Vₜ. If the deviation Δ is not significant, that is to say if Δ<Δₘₐₓ, it is unnecessary to modify the thrust
the iteration k times of the previous three steps, to determine whether the deviation Δ is greater than the maximum deviation Δₘₐₓ for the k^{th} consecutive time, and the readjustment of the current thrust so as to reduce the deviation Δ to a value less than that of the maximum deviation Δₘₐₓ. Stated otherwise, the thrust is readjusted only if the deviation Δ is regularly exceeded. The objective is to minimize the adjustments following a change of the current speed so as to preserve the engine parts and optimize the fuel consumption.

The method according to the invention is distributed over the guidance 106, prediction 104 and man-machine interface 113 functions of the architecture of the FMS.

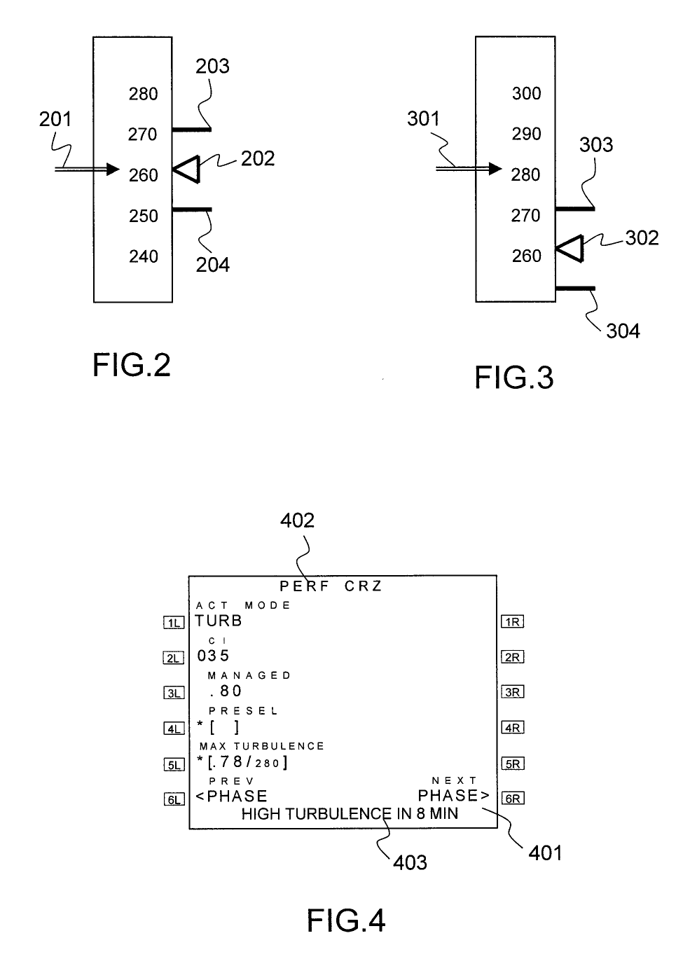

FIG. 2 presents an exemplary display of the indication of the current speed of the aircraft. An arrow 201 indicates the current speed of the aircraft. A triangle 202 indicates the recommended turbulence speed. The elements 203 and 204 represent the bounds of the range of target speeds. In this example, the current speed remains in the range. The nominal operation of the method according to the invention is the following. When the pilot activates the turbulence mode, the controlled thrust (N1 or EPR according to engine type) changes towards the value that makes it possible to hold the speed in turbulent air, dependent on the mass and the altitude of the aircraft. The speed setpoint is transmitted to the primary flight display (PFD) and displayed on the speed indicator as speed setpoint managed by the FMS. The setpoint is also displayed on the interface of the FMS (CDU Control Display Unit or FMD Flight Management Display). An acceptable speed range in turbulent air is defined about the turbulence speed. To this speed there corresponds a setpoint thrust for reaching the turbulence speed. Once the turbulence speed has been reached, at constant thrust, speed fluctuations may appear depending on the strength of the gusts encountered. With the method according to the invention, the thrust does not vary so long as the speed remains in the range. If the latter departs significantly and in a regular manner, the thrust is modified.

FIG. 3 presents an exemplary display of the indication of the current speed of the aircraft, presented to the pilot. An arrow 301 indicates the current speed of the aircraft. A triangle 302 indicates the turbulence speed. The elements 303 and 304 represent the bounds of the range of turbulence speeds. In this example, the current speed steps out of the range. If it is assumed that the setpoint thrust N1 equals 77% (of the maximum continuous power N1) the speed range may be recovered with a lower thrust value N1 for example equal to 60%.

According to a variant of the invention, the thrust can be readjusted progressively so as to return to the range. In the previous example, rather than applying a thrust of 60% to restore the speed, it is advantageously possible to control a thrust registering between 60% and 77%. A simple law can then be used to define the values of the adjustment thrust, for example, an average between the current thrust and the thrust that makes it possible to return to the range following an overstep. A simple law such as this is applicable to any type of turbomachine, valid for N1 or EPR.

The thrust adjustment time constant is sufficiently large to use a minimum of thrust adjustments. This has the effect of minimizing the consumption in the transient adjustment regime and preserving the potential of the engine parts.

The turbulence mode can be activated during the aircraft climb, cruising or descent phases, except if the current speed or setpoint speed is less than the turbulence speed (this may be the case in the low layers where there are airspace related speed restrictions). FIG. 4 represents an exemplary man-machine interface of a device for aiding navigation in turbulent air according to the invention. Such an interface is known by the term CDU for Control Display Unit. The man-machine interface comprises a display means 401 and control buttons disposed on either side of said display means 401. A first element 402 (PERF CRZ) indicates that the aircraft is in cruising phase. A second element (TURB), opposite the button 1L, indicates that the turbulence mode is activated. A third element (C1 for Cost Index), opposite the button 2L, is used for the calculation of the speed managed by the FMS. A fourth element, opposite the button 3L, represents the speed mode managed by the FMS. A fifth element, opposite the button 4L, represents the speed mode selected by the pilot. A sixth element (MAX TURBULENCE), opposite the button 5L, indicates the maximum speed to be used in turbulent air, such as calculated by the function. In this example, this speed is Mach 0.78. A seventh element 403 (HIGH TURBULENCE IN 8 MIN) signals that the aircraft will encounter high strength turbulence in eight minutes.

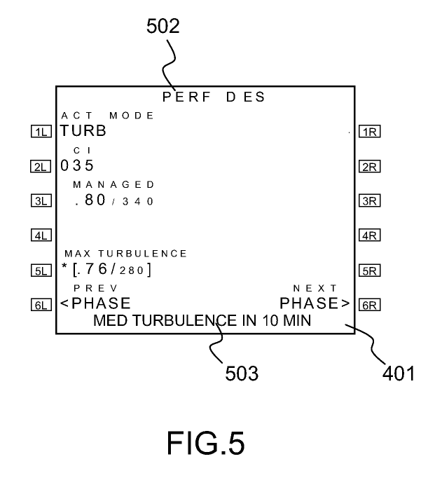

FIG. 5 presents the same man-machine interface as that of FIG. 4 but displaying different elements. A first element 502 (PERF DES) indicates that the aircraft is in the descent phase. A second element (TURB), opposite the button 1L, indicates that the turbulence mode is activated. A third element (C1 for Cost Index), opposite the button 2L, is used for the calculation of the speed managed by the FMS. A fourth element, opposite the button 3L, represents the speed mode managed by the FMS. A fifth element, opposite the button 4L, represents the speed mode selected by the pilot. A sixth element (MAX TURBULENCE), opposite the button 5L, indicates the maximum speed to be used in turbulent air, such as calculated by the function. In this example, this speed is Mach 0.76. A seventh element 503 (MED TURBULENCE IN 10 MIN) signals that the aircraft will encounter medium strength turbulence in ten minutes.

According to a variant of the invention, the device for aiding navigation in turbulent air comprises means such as a control button dedicated to the activation of the turbulence mode. In the event of turbulence encountered or forecast in the short term, when the pilot deems it necessary to reduce the speed, he is prompted to go to the performance page of the control interface of the FMS (CDU/FMD), and requests, via the dedicated button, the activation of the speed turbulence mode.

The turbulence mode can be activated when the speed mode of the FMS is “speed auto”. If the airplane is in “speed selected” mode, the dedicated button makes it possible only to arm the turbulence mode which will become active as soon as the pilot engages the “speed auto” mode. Before this mode is engaged, the FMS guidance function will take no account of the turbulence speed. However, the pilot remains free to remain in “speed selected” mode. He can still select on the system known by the term Flight Control Unit FCU a turbulence speed, as is commonly done today. This turbulence speed can be that proposed by the system or else that defined in the airplane's performance manual.

According to a variant of the invention, the device for aiding navigation in turbulent air furthermore comprises means for displaying a message signaling the activation of the turbulence mode. Such a message can take the following form “turbulence mode active”.

According to a variant of the invention, the device for aiding navigation in turbulent air furthermore comprises a means dedicated to the deactivation of the turbulence mode if the turbulence mode is activated.

According to a variant of the invention, the method of automatically managing the flight of an aircraft in turbulent air furthermore comprises a step of predicting parameters such as the fuel consumption, the flight duration, etc, on the basis of the current speed convergent to the turbulence speed, said turbulence speed being automatically maintained for an estimated duration of turbulence pegged during the activation of the turbulence mode. The predictions are calculated on the basis of the current speed for this estimated duration of turbulence after which the system assumes a return to the speed ECON established beforehand or another speed if so compelled by an active time constraint. When this estimated duration of turbulence is reached and if the pilot has not released the turbulence mode, then the turbulence speed is prolonged a second time by the same duration and so on and so forth until the pilot releases the turbulence mode or until a speed constraint compels a reduction to a lower speed. The predictions are reupdated in real time.

There is another way to estimate the point onwards of which the turbulence mode will be deactivated by considering in the predictions a sliding distance (of 100 Nm for example) up to deactivation of the turbulence mode.

In the cruising phase, the average duration of a turbulence is of the order of 15 minutes. It will be possible to consider for example a distance up to the end-of-turbulence point of the order of some hundred Nm, thereby corresponding roughly to the distance traveled in 15 minutes by a jet in the cruising phase. In the approach phase, the turbulence will be considered to last until the runway.

Like all the applicable speed restrictions, the turbulence speed is integrated within the calculation of the speed ECON which is the optimum speed reduced to the active limitations.

Additionally the aircraft may be subject to a time constraint in respect of its arrival, the so-called Required Time of Arrival or RTA. In this case, the time predictions related to the RTA continue to be calculated. The RTA continues to be slaved only if the RTA holding speed is less than the turbulence speed. If it is no longer slaved, a message then forewarns the pilot.

1. A method of automatically managing the flight of an aircraft in turbulent air comprising notably the determination of the current speed (V_{c}), of an optimal turbulence speed (Vₜ), of a current thrust value (P), comprising the following steps:
acquiring data relating to a turbulence,
determining an optimal turbulence speed,
measuring of a deviation (Δ) between the current speed (V_{c}) and the turbulence speed (Vₜ),
comparing between the deviation (Δ) and a maximum deviation value (Δₘₐₓ),
iterating k times of the previous three steps, to determine whether the deviation (Δ) is greater than the maximum deviation (Δₘₐₓ) for the k^{th} consecutive time, and the readjustment of the current thrust (P) so as to reduce the deviation (Δ) to a value less than that of the maximum deviation (Δₘₐₓ) and to make the current speed (V_{c}) converge to the turbulence speed (Vₜ).

2. The method of automatically managing the flight of an aircraft in turbulent air as claimed in claim 1, wherein the step of readjusting the current thrust is done progressively.

3. The method of automatically managing the flight of an aircraft in turbulent air as claimed in claim 1, wherein the data relating to a turbulence comprise the altitude and the strength of the turbulence.

4. The method of automatically managing the flight of an aircraft in turbulent air as claimed in claim 1, wherein the optimal turbulence speed is calculated as a function of the altitude and of the mass of the aircraft.

5. The method of automatically managing the flight of an aircraft in turbulent air as claimed in claim 1, wherein the optimal turbulence speed is equal to a value provided by the constructor.

6. The method of automatically managing the flight of an aircraft in turbulent air as claimed in claim 1, wherein the optimal turbulence speed is determined manually by the pilot so as to be substituted temporarily for the calculated value.

7. The method of automatically managing the flight of an aircraft in turbulent air as claimed in claim 6, which comprises the automatic determination of the optimal turbulence speed after stopping the manual determination of said speed by the pilot.

8. The method of automatically managing the flight of an aircraft in turbulent air as claimed in claim 1, which furthermore comprises a step of predicting parameters such as the fuel consumption and the flight duration, on the basis of the current speed convergent to the turbulence speed, said turbulence speed being assumed to be maintained automatically for prediction purposes for an estimated duration of turbulence.

9. A device for aiding navigation in turbulent air implementing the method as claimed in one of claim 1, having available a man-machine interface comprising a display means and control buttons disposed on either side of said display means, wherein said man-machine interface comprises means dedicated to the activation of the turbulence mode.

10. The device for aiding navigation in turbulent air as claimed in claim 9, which furthermore comprises means for displaying a message signaling the activation of the turbulence mode.

11. The device for aiding navigation in turbulent air as claimed in claim 9, wherein the man-machine interface furthermore comprises means dedicated to the deactivation of the turbulence mode.
